(19) United States
(12) Patent Application Publication
(10) Pub. No.: US 2003/0203722 A1
(43) Pub. Date: Oct. 30, 2003

(54) Method of reducing power consumption in a radio receiver

(76) Inventors: Richard K. Karlquist, Cupertino, CA (US); Ken A. Nishimura, Fremont, CA (US); Jerry J. Liu, Sunnyvale, CA (US); Matthew Johnson, Half Moon Bay, CA (US); Michael C. Higgins, Palo Alto, CA (US); Robert T. Martin, Cupertino, CA (US)

Correspondence Address: AGILENT TECHNOLOGIES, INC., Legal Department, DL429, Intellectual Property Administration, P.O. Box 7599, Loveland, CO, 80537-0599, US

(21) Appl. No.: 10/136,765

(22) Filed: Apr. 30, 2002

(51) Int. Cl. H04B 1/00; H04B 17/00

(52) U.S. Cl. 455/130; 455/226.1

(57) ABSTRACT

Reduced power consumption in a receiver. Power consumption is reduced in a receiver by operating portions of the receiver such as the first RF amplifier, local oscillator, and associated phase locked loop at reduced power in a standby mode, trading lower power for lower performance. In a normal operating mode, these portions of the receiver operate at full power and performance.

### BACKGROUND OF THE INVENTION

1. Field of the Invention

The present invention pertains to methods of reducing power consumption in radio receivers.

2. Art Background

In battery operated digital wireless devices such as pagers and portable telephones, battery life in standby mode is dominated by receiver current drain. Standby mode is typified by a pager waiting to receive a page, or a wireless telephone awaiting an incoming call or the command from the user to initiate placing a call. In many device designs, portions of the device are selectively powered off or put into a low-current consumption mode until they are needed. While the receiver front end, generally comprising an RF amplifier, mixer, and local oscillator, may be pulsed on and off periodically to reduce current drain, the receiver front end still dominates in terms of current drain with the device in standby mode.

What is needed is a way to further reduce power consumption in wireless devices.

### SUMMARY OF THE INVENTION

Power consumption in standby mode of a receiver is reduced by operating the receiver front end in one of two modes. In the standby mode, the receiver operates in a low-power mode at the expense of operating performance characteristics such as phase noise, frequency stability, and dynamic range. When a signal is received, the receiver switches to full power operating mode, where the receiver operates in normal mode with full performance characteristics such as lowered phase noise, improved frequency stability, and improved dynamic range.

### BRIEF DESCRIPTION OF THE DRAWINGS

The present invention is described with respect to particular exemplary embodiments thereof and reference is made to the drawings in which:

FIG. 1 is a diagram of a receiver,

FIG. 2 is a diagram of a phase locked loop, and

FIG. 3 is a diagram of a receiver with a second signaling channel.

### DETAILED DESCRIPTION

Most of the time, wireless devices such as telephones, pagers, and the like operate in a standby mode awaiting the reception of a signal. While portions of the receiver and ancillary electronics such as display drivers and audio amplifiers may be operated in a lower power standby mode, typically the receiver front end is consuming its full operating power. While it is known to the art to operate the receiver at a low duty cycle, for example, powering up for a few milliseconds every half second to check for a signal, the power consumption of the receiver front end when powered up still dominates standby power consumption of the device, which limits its standby lifetime on a set of batteries.

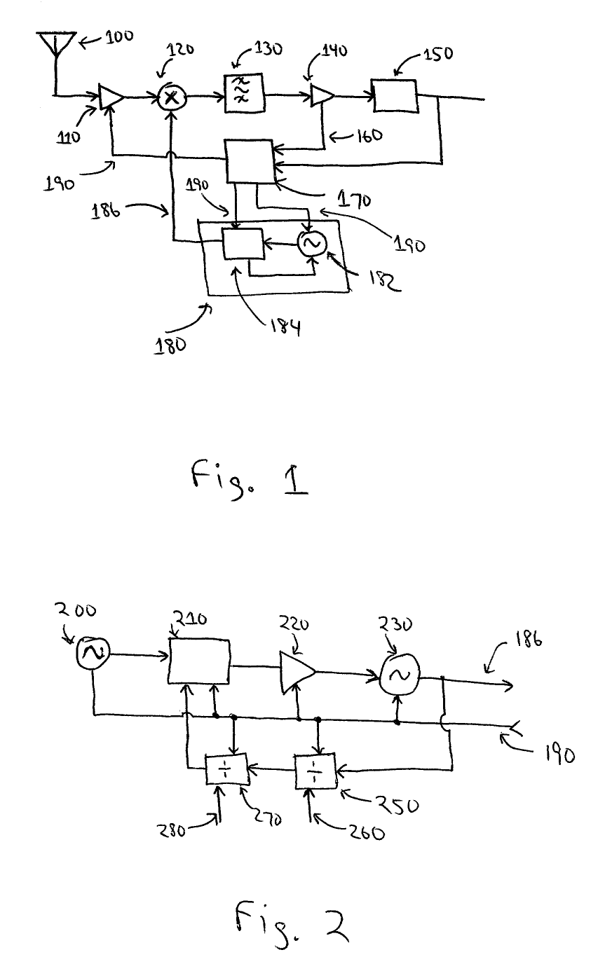

FIG. 1 shows a receiver with features according to the present invention. For purposes of simplification, known structures used in a combined transmitter/receiver such as antenna duplexing and transmitter functional blocks, user interfaces such as keyboards, displays, microphones, speakers, and their ancillary circuitry are not shown. Antenna 100 feeds RF amplifier 110. In some designs, the RF amplifier may not be needed. Mixer 120 mixes the amplified 110 input signal with local oscillator signal 186 produced by local oscillator block 180. For a superheterodyne design, the output of mixer 120 is at an intermediate frequency (IF), which is band-pass filtered 130 and amplified by one or more IF amplifiers 140 before being sent to demodulator 150. In a direct conversion design, the output of mixer 120 is a baseband signal which is low-pass filtered, amplified, and demodulated 150. Output 160 of IF stage 140 represents an automatic gain control (AGC) signal, or in more complex designs, a received signal strength indicator (RSSI) signal representing the strength of the received signal.

Local oscillator block 180 typically comprises a reference oscillator 182 and a phase locked loop 184, producing a local oscillator signal 186 for mixer 120.

These blocks and others not shown are operated by controller 170, typically a microprocessor, which uses control lines 190 to control portions of the device.

Modern wireless devices, particularly those using complex digital coding methods such as GMSK or QPSK, require a local oscillator signal which is very stable and has very low phase noise so that the demodulator will be able to recover the data impressed on the carrier signal. In contrast, the much simpler process of detecting the presence of a carrier on a particular frequency, or of demodulating a much lower data rate signal can be performed using a local oscillator with much less restrictive stability and phase noise levels.

In a receiver according to the present invention, the receiver is operated in a low-power relaxed-performance mode in standby, and switched to its higher-power, full performance mode during normal operation.

In one aspect of the present invention, where mixer 120 uses a topology such as a Gilbert cell, bias current to the Gilbert cell may be reduced greatly at the expense of dynamic range. IF signal strength indicator 160 is used as a carrier sense signal to switch the receiver from standby to full operating mode whenever a suitable signal is present. Controller 170 senses signal 160 and switches mixer 120 from low power, standby mode to full power mode, improving its dynamic range.

As RF amplifiers consume power, another power saving aspect of the present invention is to power down the initial RF amplifier for the receiver and connect the antenna directly to the mixer during standby operation.

In another aspect of the present invention, local oscillator block 180 is operated in a low-power relaxed-performance mode in standby, and switched to its higher-power, full performance mode during normal operation. IF signal strength indicator 160 is used as a carrier sense signal to switch the receiver from standby to full operating mode whenever a suitable signal is present. Controller 170 senses signal 160 and switches local oscillator block 180 from low power, standby mode to full power mode. This approach may be combined with switching mixer bias current.

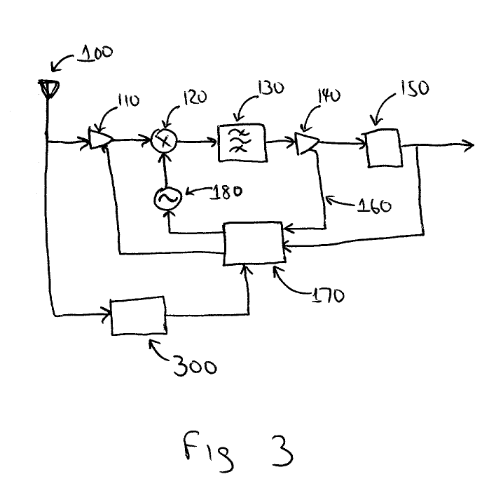

FIG. 2 shows a phase locked loop (PLL) for the present invention. It will be recognized by those familiar with the phase locked loop art that the present invention is equally applicable to many different PLL topologies. Reference oscillator 200 provides a frequency reference to the PLL. Voltage controlled oscillator (VCO) 230 produces output signal 186. The frequency of output signal 186 is divided down by prescaler 250 and divider 270. Prescale ratio is set by inputs 260. The divider ratio is set by inputs 280. The output of reference oscillator 200 is combined with the output of divider 270 in phase detector 210. The output of phase detector 210 is filtered by loop filter 220, which drives VCO 230. Control line 190 connects the individual PLL blocks to controller 170.

In general, the higher the performance and lower the phase noise of the PLL, the higher its current consumption. Current consumption in the PLL can be reduced, at the expense of phase noise by lowering the VCO oscillator bias current. Other techniques which reduce current consumption at the expense of phase noise include reducing prescaler 250 bias and voltage swing, reducing overall PLL bandwidth, and/or changing prescaler 250 and PLL divider 270 ratios. Other approaches to saving power in PLL 180 include using a lower reference oscillator frequency 200 for the PLL, and using a larger minimum step size.

In another embodiment of the present invention, low data-rate modulation is used to transmit a signal to wake up the wireless unit. In this embodiment, controller 170 monitors the output of demodulator 150 for a signal to wake up the unit, such as a beacon, broadcast code, identification code, or the like A technique as simple as detecting the presence of a carrier through sensing signal strength/RSSI signal 160 may also be used. The identification code may be a group code assigned to a group of devices, such as those supplied to a particular company or department, may be unique identifiers assigned to each device, or a combination. While a low data-rate signal, such as wide FSK, is spectrally inefficient compared to GMSK or QPSK, low data-rate signals can tolerate much more phase noise and still be successfully demodulated. Thus, techniques already described for reducing current consumption, such as reducing mixer bias current in a Gilbert cell mixer, and relaxing PLL/Local oscillator performance to achieve power savings may be used.

FIG. 3 shows another aspect of the invention. In this embodiment, a separate receiver chain 300 is dedicated to receiving a signal to switch the unit from standby to active mode. This receiver is optimized for low-power performance on a single frequency. This receiver may be a direct-conversion design, or a more traditional superheterodyne. The signaling frequency used by this receiver need not be in the same frequency range as the main receiver. As an example, the frequency used could be an SCA subcarrier on a commercial FM broadcast station, or other high-power beacon transmitter.

The foregoing detailed description of the present invention is provided for the purpose of illustration and is not intended to be exhaustive or to limit the invention to the precise embodiments disclosed. Accordingly the scope of the present invention is defined by the appended claims.

We claim:

1. A wireless digital device having a receiver, the receiver having a first normal operating mode and operating characteristics, and a second standby mode in which the receiver operates in a lower power mode having reduced operating characteristics.

2. The device of claim 1 where the receiver has a mixer fed by a local oscillator.

3. The device of claim 2 where a first local oscillator is used for the first normal operating mode, and a second local oscillator with reduced power consumption is used in the second standby mode.

4. The device of claim 2 where the mixer is a Gilbert Cell mixer having a first bias level in the first normal operating mode, and a second lower power bias mode in the second standby mode.

5. The device of claim 2 where the local oscillator comprises a phase locked loop which is operated in a first normal mode and a second lower power standby mode by altering phase locked loop parameters between the first and second modes.

6. The device of claim 5 where the phase locked loop includes a prescaler and the parameter altered is the prescaler ratio.

7. The device of claim 5 where the phase locked loop includes a reference oscillator and the parameter altered is the reference frequency.

8. The device of claim 5 where the phase locked loop includes a divider and the parameter altered is the divider ratio.

9. The device of claim 1 where the receiver has a receive RF amplifier which is used in the first operating mode and not used in the second standby mode.

10. In a wireless digital device having a receiver, the receiver having a first normal operating mode and operating characteristics, and a second standby mode in which the receiver operates in a lower power mode having reduced operating characteristics, switching the receiver between the second and first operating modes based on a received signal.

11. The device of claim 10 where the received signal is an unmodulated carrier.

12. The device of claim 10 where in the first normal operating mode the receiver receives digital data at a first data rate and in the second standby mode the receiver receives digital data at a second data rate.

13. The device of claim 12 where the second data rate is lower than the first data rate.

14. The device of claim 12 where the received signal contains a broadcast code.

15. The device of claim 12 where the received signal contains an identification code for the device.

16. The device of claim 15 where the identification code for the device is unique.

17. A wireless digital device having a first normal operating mode receiver and operating characteristics, and a second standby mode receiver with lower power consumption and reduced operating characteristics.

18. The device of claim 17 where the first and second receivers operate in the same frequency band.

19. The device of claim 17 where the first and second receivers operate in different frequency bands.

20. The device of claim 17 where the second receiver operates on a single fixed frequency.
